(19) United States
(12) Patent Application Publication
(10) Pub. No.: US 2019/0219402 A1
(43) Pub. Date: Jul. 18, 2019

(54) Concept For Visually Guiding A Traveling Person

(71) Applicant: SIEMENS MOBILITY GMBH, MUENCHEN (DE)

(72) Inventors: JAN HELEBRANT, MUENCHEN (DE); STEFFEN SCHAEFER, MUENCHEN (DE)

(21) Appl. No.: 16/337,117

(22) PCT Filed: Aug. 16, 2017
(86) PCT No.: PCT/EP2017/070746

§ 371 Date: Mar. 27, 2019

(30) Foreign Application Priority Data
Sep. 27, 2016 (DE) 10 2016 218 534.9

(51) Int. Cl. G01C 21/20; H04N 21/414; G08B 7/06; H04W 4/80

(52) U.S. Cl. CPC G01C 21/20; H04W 4/80; G08B 7/066; H04N 21/41415

(57) ABSTRACT

A method visually guides a person who is carrying an identifier device, for example a mobile terminal having the identifier, and who is travelling along a route from a starting position to a destination position. The method includes correlating the identifier, in particular a UUID of the mobile terminal, a symbol representing the person and the route with one another and ascertaining a current position of the identifier device using the identifier while the person is travelling along the route. The symbol is displayed on the basis of the ascertained position and of the route by at least one display device, different from the identifier device, located along the route in order to visually guide the person from the starting position to the destination position along the route.

The invention relates to a method for visually guiding a person who is carrying an identifier means, for example a mobile terminal, comprising an identifier and who is traveling along a route from a starting position to a destination position.

The invention further relates to a system for visually guiding a person who is carrying an identifier means, for example a mobile terminal, comprising an identifier and who is traveling along a route from a starting position to a destination position.

The invention relates to a display device for a system for visually guiding a person who is carrying an identifier means, for example a mobile terminal, comprising an identifier and who is traveling along a route from a starting position to a destination position.

The invention further relates to a computer program.

In the case of navigation in local public transport in unknown terrain, a traveler is often faced with the question of from which track platform their underground train or train will travel. In particular, a traveler is often faced with the question of which exit they have to take in order to change trains or to reach their destination. In particular, a traveler is often faced with the question of whether the next stop is the stop at which they have to exit.

Navigation in local public transport is generally much more complex than navigation with a motor vehicle. As a rule, the traveler can rarely navigate by means of his smartphone because, on the one hand, the required map material does not exist. On the other hand, the localization that can be achieved using a smartphone is often insufficient. There is currently no comprehensive digital map material for railway stations in particular.

Furthermore, as a rule, positioning by means of GPS within a railway station is not sufficient. This applies in particular to underground railway stations where usually no GPS signal is available.

Offenlegungsschrift WO 2015/082717 A1 discloses a personalized guidance system.

Offenlegungsschrift US 2016/0277886 A1 discloses a method for controlling a network of dynamic display devices.

The object underlying the invention is therefore to provide an efficient concept for efficiently visually guiding a traveler, with the person traveling along a route from a starting position to a destination position.

This object is achieved by means of the respective subject matter of the independent claims. Advantageous embodiments of the invention are the subject matter of dependent claims in each case.

According to one aspect, a method is provided for visually guiding a person who is carrying an identifier means, for example a mobile terminal, comprising an identifier and who is traveling along a route from a starting position to a destination position, comprising the following steps:

correlating the identifier, in particular a UUID of the mobile terminal, of a symbol representing the person and the route with one another,
ascertaining a current position of the identifier means using the identifier while the person is traveling along the route,
displaying the symbol on the basis of the ascertained position and of the route by means of at least one display device, different from the identifier means and located along the route in order to visually guide the person along the route from the starting position to the destination position.

According to another aspect, a system is provided for visually guiding a person who is carrying an identifier means, for example a mobile terminal, comprising an identifier and who is traveling along a route from a starting position to a destination position, comprising

a processor for correlating the identifier, in particular a UUID of the mobile terminal, of a symbol representing the person and the route with one another and
for ascertaining a current position of the identifier using the identifier while the person travels along the route, and
at least one display device different from the identifier means and located along the route for displaying the symbol on the basis of the ascertained position in order to visually guide the person along the route from the starting position to the destination position.

According to another aspect, a display device is provided for a system for visually guiding a person who is carrying an identifier means, for example a mobile terminal, comprising an identifier and who is traveling along a route from a starting position to a destination position.

According to another aspect, a computer program is provided comprising program code for carrying out the inventive method for visually guiding a person when the computer program is executed on a computer.

The invention is based on the recognition that the above object is achieved in that the traveler is guided using one or more display device(s) which are arranged externally of the identifier means, for example, the mobile terminal.

In order to be able to individually guide the individual people even in the case of a plurality of people to be guided, it is inventively provided that a symbol which represents the person is assigned to the person. This symbol therefore identifies the person. The person knows this symbol.

In one embodiment it is provided that the symbol will be or is permanently assigned to a person. Permanent means, for example, up to an instant at which the person decides to change the symbol.

In one embodiment it is provided that the symbol is randomly selected for each journey and is individually communicated to the traveler.

In one embodiment it is provided that a symbol will be or is used for a plurality of travelers who are all traveling to the same location. Such a location is, for example, a concert or a restaurant.

If a particular symbol is displayed by means of a display device, therefore, the relevant person (or people who are traveling to the same location) knows that it is they who are meant. This means, therefore, that the visual indication of the display device is individually ascertained for this person. Other people do not therefore generally feel they are being addressed by said symbol. This is because, as a rule, this symbol has no meaning for other people, at least no meaning which relates to visual instructions within the context of navigation or guidance.

In other words, therefore, the symbol is an identification for the person. The fact that, as a rule, this symbol is only known to the traveler themself means that it can be advantageously displayed on public display devices without data protection problems. Since, as a rule, other people are also in the vicinity of the person to be guided, it is difficult to infer the owner of the symbol, in other words the person.

The inventive correlation of the identifier of the identifier means, which is, for example, a mobile terminal, with the symbol advantageously means that even in the case of a plurality of identifier means, for example mobile terminals, the symbol pertaining to a particular identifier means, for example to a particular mobile terminal, and therefore to the person carrying this identifier means, can be efficiently ascertained.

Inventive correlation of the route with the identifier advantageously means that once the identifier of the identifier means is detected, the associated route is also known.

The fact that the symbol is displayed by means of a display device which is different from the identifier means, in particular has the technical advantage that, if the identifier means is a mobile terminal, the traveler does not constantly direct his gaze to the mobile terminal, which can normally severely restrict the awareness of the person. Instead, the route guidance is embedded in buildings or vehicles in the real world and this simplifies navigation.

The fact that the display device displays the symbol means the traveler is not forced to look constantly at the mobile terminal but can direct their attention to their surroundings instead in order to see or recognize the visual indication, in other words the symbol, which is represented by means of the display device. As a result, the person's safety is in particular increased in an advantageous manner to the extent that a risk of collision of a collision with other people or objects can be reduced.

Therefore, in particular, the technical advantage is achieved that an efficient concept for efficiently visually guiding a traveler is provided, with the person traveling along a route from a starting position to a destination position.

The wording “at least one display device” includes in particular the wording “one or more display device(s)”.

In the case of a plurality of display devices, these are, for example, designed differently or, for example, identically.

A position of the display device is known.

Guiding means, in particular, guidance.

According to one embodiment, the identifier means comprises or is a mobile terminal.

According to one embodiment, the identifier means comprises or is an RFID tag.

According to an embodiment, the identifier means comprises or is a BLE tag.

A “tag” can also be referred to as an electronic tag.

Where embodiments are described below which comprise a mobile terminal as the identifier means, then this should always be taken to include the more general term, identifier means.

According to one embodiment, the identifier is a UUID.

In particular this brings about the technical advantage that the identifier means, in particular the mobile terminal, can be efficiently identified.

The abbreviation “UUID” as used in the context of the description stands for “Universally Unique Identifier”.

According to one embodiment, it is provided that the at least one display device, in response to reception of a radio signal, in particular a Bluetooth LE signal, emitted by the identifier means, in particular by the mobile terminal, and comprising the identifier transmits a message comprising the identifier about reception of the identifier emitted to a server via a communication network, wherein the server, in response to reception of the message transmitted by the at least one display device transmits the symbol corresponding to the identifier to the at least one display device via the communication network.

In particular this brings about the technical advantage that the identifier means, in particular the mobile terminal, can be efficiently localized. This means, therefore, that the current position of the identifier means can be efficiently ascertained.

In one embodiment it is provided that the radio signal comprising the identifier is a Bluetooth LE signal.

The abbreviation “LE” as used within the context of the description stands for “Low Energy”. This means, therefore, in particular, that the radio signal is, for example, a radio signal according to the Bluetooth low energy standard.

“Bluetooth low energy” can also be abbreviated to BLE above and below.

A radio signal within the meaning of the description is, for example, a Bluetooth signal, in particular a BLE signal.

This means, therefore, for example, that the identifier means, in particular the mobile terminal, is operated according to one embodiment as an “iBeacon”.

The term “iBeacon” is a brand name belonging to Apple Inc. and designates a proprietary standard for navigation in closed spaces based on BLE signals.

In one embodiment the identifier means is operated according to the proprietary standard “Google Eddystone”.

A radio signal within the meaning of the description is, for example, an RFID signal.

According to one embodiment, the identifier means is a mobile terminal, wherein the at least one display device emits a radio signal, in particular a Bluetooth LE signal, comprising a display device identifier, wherein a server, in response to reception of a message transmitted by the mobile terminal via a communication network and comprising the display device identifier and the identifier, transmits the symbol corresponding to the identifier via the communication network to the display device corresponding to the display device identifier.

This brings about, for example, the technical advantage that the symbol can be efficiently supplied to the display device.

The server which receives the message from the mobile terminal is, for example, the server to which the display device transmits the message about reception of the radio signal emitted by the identifier means, in particular by the mobile terminal.

According to one embodiment, the communication network comprises a wireless and/or wired communication network.

According to one embodiment, the communication network comprises the Internet.

According to one embodiment, the communication network is the Internet.

In other words, therefore, in particular according to one embodiment it is provided that the display device is operated as an “iBeacon” or according to the “Google Eddystone” proprietary standard.

In one embodiment it is provided that the identifier means, in particular the mobile terminal, emits a radio signal, in particular a Bluetooth LE signal or RFID signal, comprising the identifier.

According to one embodiment, it is provided that the identifier means, in particular the mobile terminal, receives a radio signal, in particular a Bluetooth LE signal, emitted by the display device and comprising a display device identifier.

In response to reception of the radio signal emitted by the display device, it is, for example, provided that the mobile terminal transmits a message comprising the display device identifier and the identifier of the mobile terminal device to the server via a communication network.

In one embodiment it is provided that one of the at least one display device is arranged within a passenger transport vehicle stopping at a plurality of stations, wherein the one display device displays the symbol immediately before the next station at which the person has to exit during the course of their journey.

In particular this brings about the technical advantage that the person can be efficiently informed that they have to exit at the next station. This brings about, therefore, the technical advantage that the person cannot miss the station at which they have to exit. This brings about, for example, the technical advantage that a journey time of the person is not unnecessarily prolonged if the latter has missed their station.

In one embodiment it is provided that one of the at least one display device is arranged is arranged at a stop, for example on a track platform or on a bus platform, at which the person must board a passenger transport vehicle during the course of their journey.

This brings about, for example, the technical advantage that the person can be efficiently informed where they have to board the passenger transport vehicle. As a result, for example a search time for the stop is efficiently shortened.

The track platform is incorporated by a railway station, for example.

A passenger transport vehicle within the meaning of the description is, for example, a bus, a tram, an underground train, a rail vehicle or a watercraft.

In one embodiment it is provided that prior to correlating, the person is provided with a plurality of symbols from which the person can select the symbol to be correlated so that the symbol selected by the person is used as the symbol to be correlated.

In particular this brings about the technical advantage that acceptance by the person of the inventive concept can be further increased to the extent that the latter now only has to select one from a plurality of symbols, and this efficiently simplifies use of the inventive concept or the implementation.

In one embodiment it is provided that the person themself creates their symbol and communicates it, for example, to the server.

According to one embodiment, it is provided that a symbol within the meaning of the description is one of the following symbols or a combination of one or more of the following

symbol(s): an icon, one or more letter(s), one or more number(s), an alphanumeric code, in other words a symbol string comprising one or more letter(s) and one or more number(s), an emoji, in particular a personalized emoji, a pictogram and a photograph.

According to one embodiment, it is provided that, in addition to the symbol, travel information based on the route is also displayed for the person by means of the at least one display device.

This brings about, for example, the technical advantage that the person can be efficiently informed of still relevant information for their journey.

Travel information comprises, for example, the information as to whether the journey will be delayed because, for example, a passenger transport vehicle is late.

Travel information comprises, for example, the information as to which direction the person has to take in order to continue to travel along their route.

In one embodiment it is provided that the at least one display device is in each case one element selected from the following group of display devices: screen, video projector, laser projector.

This brings about, for example, the technical advantage that the symbol can be efficiently displayed.

In the case of a plurality of display devices, these are arranged, for example, in a spatially distributed manner.

A display device is arranged, for example, in a stationary manner.

A display device is arranged, for example, within a passenger transport vehicle.

A display device is arranged, for example, within a railway station.

In one embodiment it is provided that the system for visual guidance is designed or set up to perform or carry out the method for visual guidance.

In one embodiment it is provided that the method for visual guidance is performed or carried out by means of the system for visual guidance.

Method features result, in particular, from corresponding system features and vice versa.

This means, in particular, that technical functionalities of the system result from corresponding technical functionalities of the method and vice versa.

This means, in particular, that the display device is designed, for example, to receive the radio signal comprising the identifier, emitted by the identifier means, in particular by the mobile terminal. This means, in particular, that the display device is designed, in response to reception of the radio signal emitted by the identifier means, in particular by the mobile terminal, to transmit a message comprising the identifier about reception of the radio signal emitted by the identifier means to a server via a communication network.

According to one embodiment it is provided that the server is designed, in response to reception of the message transmitted by the at least one display device, to transmit the symbol corresponding to the identifier to the at least one display device via the communication network.

According to one embodiment, a server is provided.

According to one embodiment, the system comprises the server.

According to one embodiment, the server is provided within the framework of the method.

The server comprises, for example, the processor.

In one embodiment it is provided that the at least one display device is designed to emit a display device identifier, in particular a Bluetooth LE signal.

According to one embodiment, it is provided that the server is designed, in response to reception of a message transmitted by the mobile terminal via a communication network and comprising the display device identifier and the identifier, to transmit the symbol corresponding to the identifier to the display device corresponding to the display device identifier via the communication network.

According to one embodiment it is provided that the server is designed or set up to receive a message transmitted by the mobile terminal via a communication network and comprising the display device identifier and the identifier.

In one embodiment the system comprises the identifier means, in particular the mobile terminal.

In order to transmit and receive the corresponding radio signals it is provided, in particular, that the identifier means, in particular the mobile terminal, or the at least one display device or the server each have a communication interface designed for transmitting or receiving. A communication interface of this kind is therefore designed, in particular, to receive or transmit a corresponding radio signal.

The communication interface is in each case designed, for example, to transmit or receive corresponding messages, as described above and/or below.

A communication interface within the meaning of the description therefore comprises, in particular, a Bluetooth communication interface and/or a mobile radio or WLAN communication interface and/or an RFID communication interface.

The wording “or” comprises, in particular, the wording “and/or”.

A mobile terminal is, for example, a mobile telephone.

A mobile terminal is, for example, a smartphone.

A mobile terminal is, for example, a tablet.

A mobile terminal is, for example, a smart watch.

In one embodiment the display device comprises a computer or is operated by means of a computer. The computer is designed, for example, as an embedded PC (embedded computer). The computer is integrated, for example, in the display device.

The computer is designed, for example, to transmit a request to a server comprising the processor that the server should return the symbol associated with the received identifier of the identifier means. The server receives this request, for example, and can ascertain the symbol associated with the identifier by means of the processor on the basis of the correlation carried out and can return it to the computer making the request.

The computer thereupon operates the display device in such a way that it displays the symbol.

The above-described properties, features and advantages of this invention and the manner in which they are achieved will become clearer and more understandable in connection with the following description of the exemplary embodiments which are explained in more detail in connection with the drawings, wherein

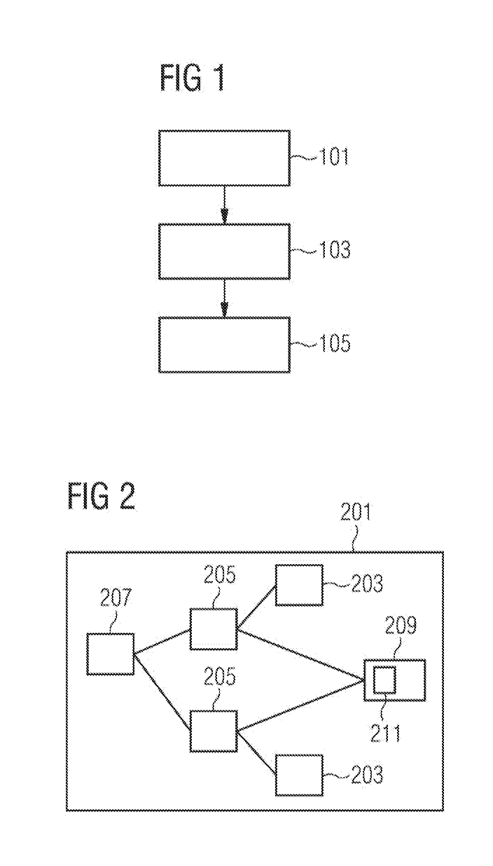

FIG. 1 shows a flowchart of a method for visual guidance,

FIG. 2 shows a system for visual guidance,

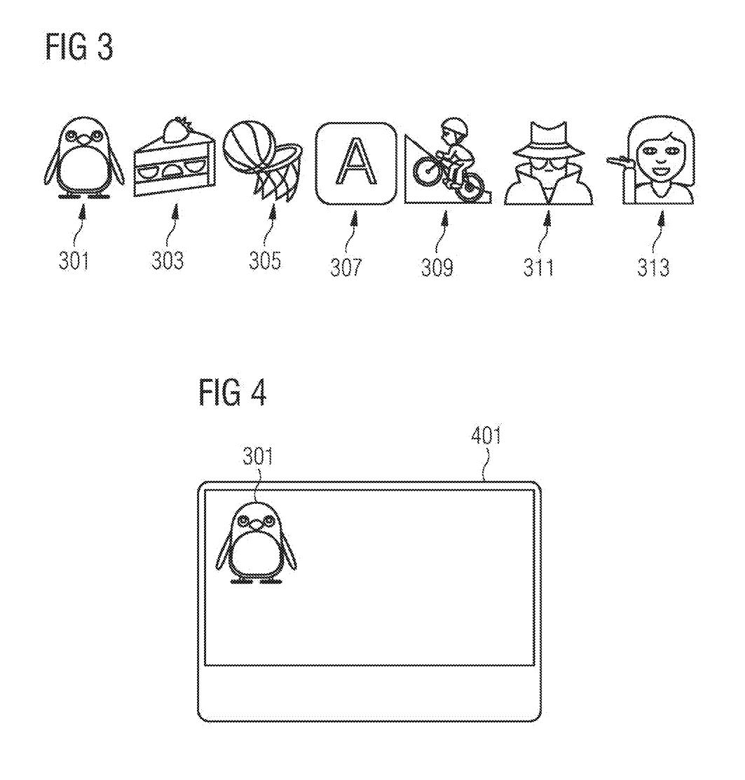

FIG. 3 shows a plurality of symbols,

FIG. 4 shows a display device,

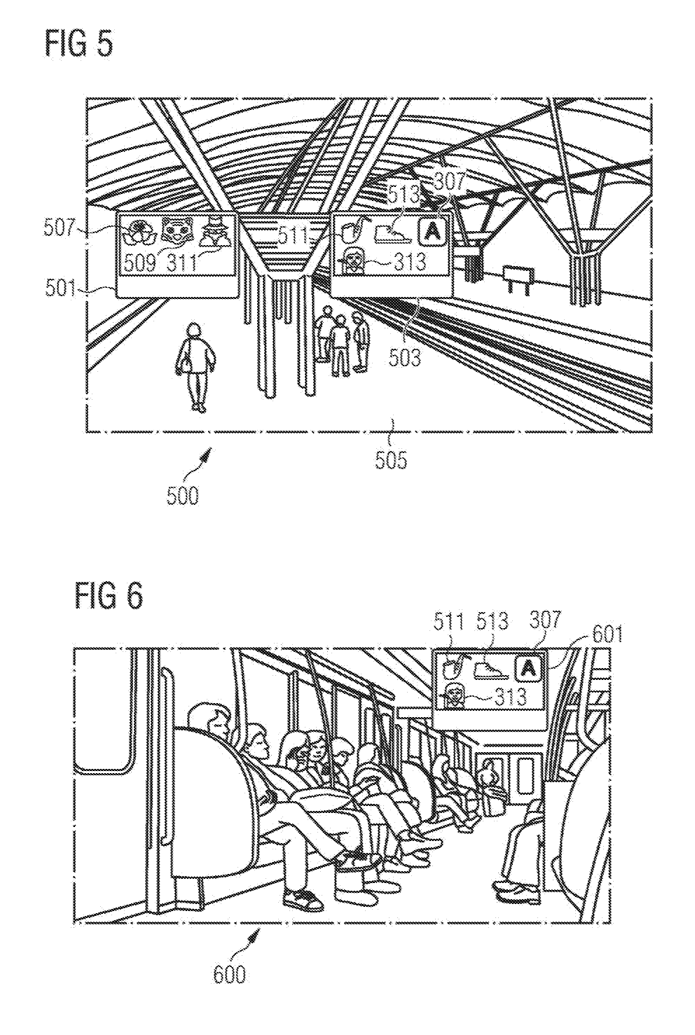

FIG. 5 shows a railway station,

FIG. 6 shows an interior of an underground train,

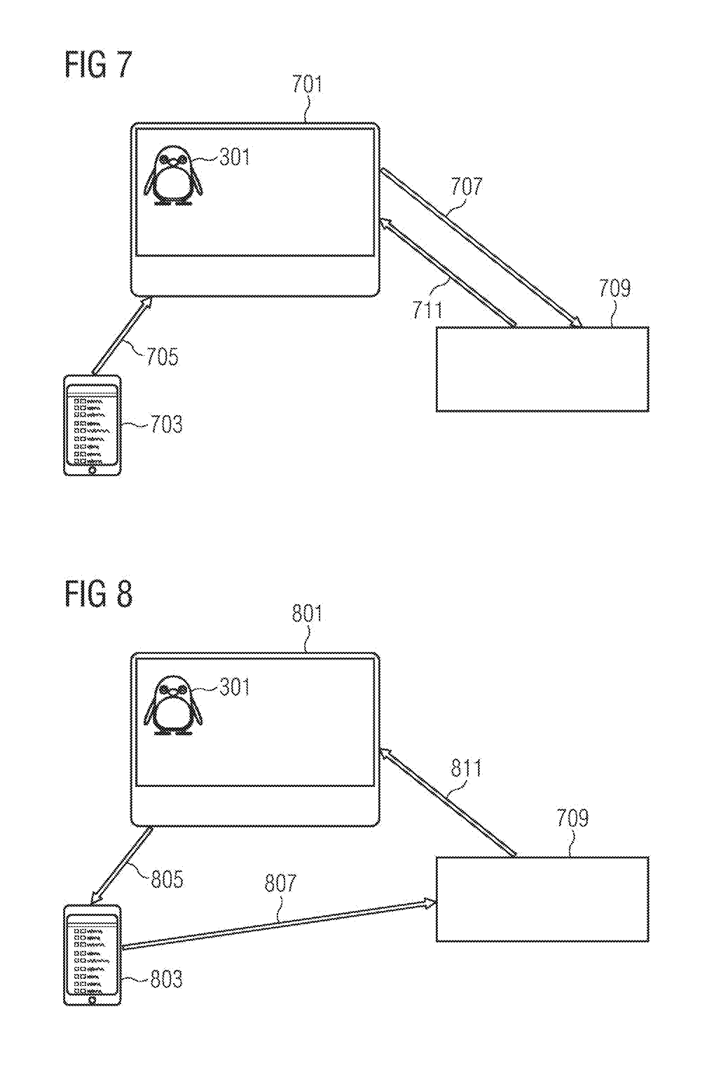

FIG. 7 shows a display device

FIG. 8 shows a display device and

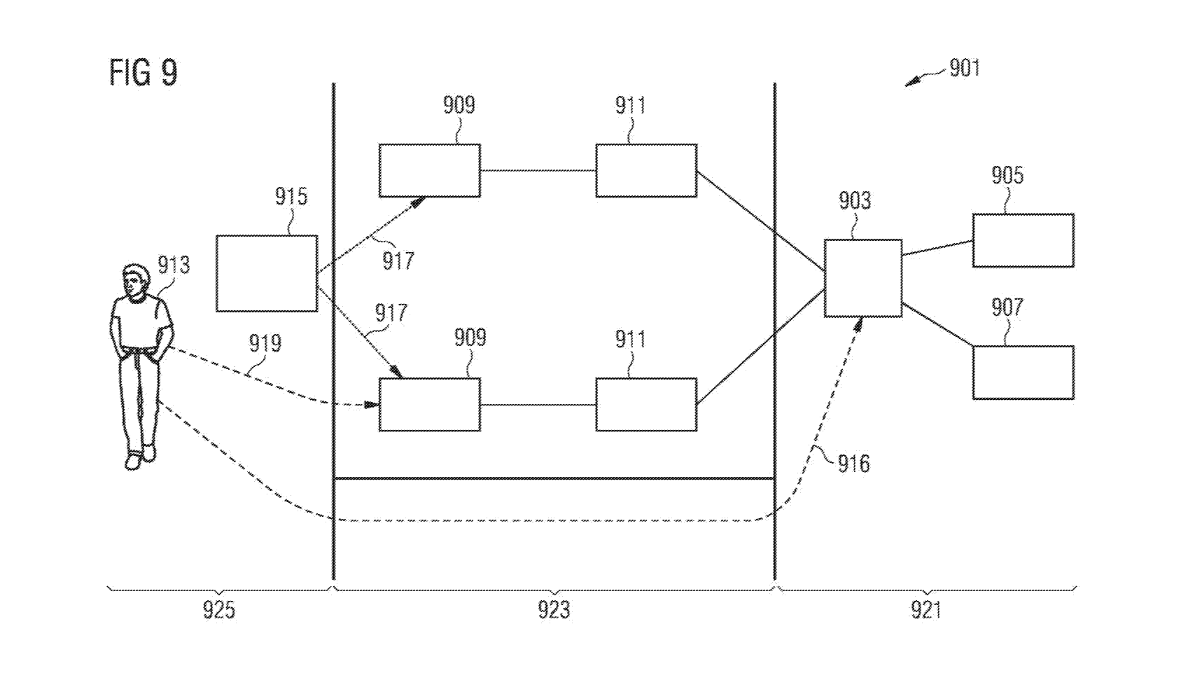

FIG. 9 shows a further system for visual guidance.

In the following, identical reference symbols can be used for the identical features.

If mobile terminals are used in the following exemplary embodiments, the more general wording “identifier means” should always be implicitly understood.

FIG. 1 shows a flowchart of a method for visually guiding a person who is carrying a mobile terminal and who is traveling along a route from a starting position to a destination position.

The method comprises the following steps:

correlating 101 an identifier, in particular a UUID, of the mobile terminal, of a symbol representing the person and the route with one another,
ascertaining 103 a current position of the mobile terminal using the identifier while the person is traveling along the route,
displaying 105 the symbol on the basis of the ascertained position and of the route by means of at least one display device, different from the mobile terminal and located along the route in order to visually guide the person along the route from the starting position to the destination position.

FIG. 2 shows a system 201 for visually guiding a person (not shown, hereinafter also called traveler) carrying a mobile terminal 207 and traveling along a route from a starting position to a destination position.

The system 201 comprises a server 209 comprising a processor 211. The server 209 is designed, for example, as an embedded computer. The processor 211 of the server 209 is designed to correlate an identifier of the mobile terminal 207, a symbol representing the person and the route with one another and for ascertaining a current position of the mobile terminal 207 using the identifier while the person travels along the route.

The system 201 further comprises two display devices 205, which are different from the mobile terminal and are located along the route, for displaying the symbol on the basis of the ascertained position in order to visually guide the person along the route from the starting position to the destination position.

In an embodiment, which is not shown, the system 201 comprises more or less than two display devices 205.

The display devices 205 are each operated by means of a computer 203 which can be designed, for example, as an embedded computer (embedded PC). The computer 203 is, for example, integrated in the display device 205.

The traveler carries their mobile terminal 207 with them. The traveler plans, for example for their journey a route using a route planning function provided by means of the server 209. The server 209 therefore knows the route of the traveler.

The traveler selects, for example, a symbol from a plurality of symbols which are intended to identify them, wherein the plurality of symbols is provided, for example, by the server 209. The symbol is, for example, an emoji.

The mobile terminal 207 of the traveler transmits, for example, its UUID to the server 209. The server 209 assigns the selected symbol and the UUID to the route. This means that the route, the UUID and the symbol are correlated with one another by means of the processor 211.

Since the server 209 knows the route, it can use the display devices 205, which are arranged along the route, for visually guiding the traveler. The positions of the display devices 205 are known to the server 209.

During their journey along the route, the traveler comes within radio range of one of the display devices 205. Their mobile terminal 207 transmits, for example during the journey, a BLE signal comprising the UUID. The display devices 205 receive the BLE signal.

If the display device 205 receives the BLE signal comprising the UUID, the associated computer 203 of the display device 205 transmits a request to the server 209 that the server 209 should return the symbol associated with the received UUID. The server 209 receives this request and can ascertain the symbol associated with the UUID by means of the processor 211 on the basis of the correlation carried out and can transmit it to the computer 203 making the request. The computer 203 thereupon operates the display device 205 in such a way that the computer displays the symbol of the traveler in order to route the traveler.

The traveler therefore no longer necessarily has to look at his mobile terminal 207 during their journey, but rather looks at the display devices 205 instead.

FIG. 3 shows a plurality of symbols 301, 303, 305, 307, 309, 311, 313 which can be used to represent a person.

A symbol within the meaning of the description is, for example, a personal icon of the person or their avatar.

FIG. 4 shows a display device 401 which displays the symbol 301 according to FIG. 3 by way of example in order to visually guide the person, who is represented by the symbol 301, along a route from a starting position to a destination position.

Since, as a rule, the symbol 301 is only known to the person who is represented by this symbol, as a rule, only this person will feel they are also being addressed by this visual indication. As a rule, other people ignore the symbol 301 and cannot be guided by this symbol. Therefore, it can be efficiently achieved that only the person who is represented by the symbol 301 is visually guided.

FIG. 5 shows a railway station 500. The railway station 500 comprises two display devices 501, 503 arranged above a track platform 505.

The two display devices 501, 503 each show a plurality of symbols 307, 311, 313, 507, 509, 511, 513 in order to visually signal to the associated people that these people have to board at the corresponding platform of the track platform 505.

FIG. 6 shows an interior of an underground train 600. A display device 601 is arranged in the interior of the underground train 600.

The display device 601 displays a plurality of symbols 307, 313, 511, 513 in order to visually inform the associated people that they have to exit the underground train 600 at the next station.

FIG. 7 shows a display device 701 and a mobile terminal 703.

The mobile terminal 703 emits a BLE signal which is symbolically identified by an arrow with the reference numeral 705. This BLE signal 705 comprises an identifier of the mobile terminal 703, for example a UUID.

The display device 701 receives the BLE signal 705 and transmits a message to a server 709 via a communication network, with this message comprising the identifier of the mobile terminal 703. The transmission of this message is symbolically represented by an arrow with the reference numeral 707.

This message comprises, for example, a request to the server 709 that the server 709 should transmit the symbol associated with the identifier of the mobile terminal 703 to the display device 701 via the communication network.

The server 709 receives the message from the display device 701 and ascertains the associated symbol based on the identifier. For example, the server 709 reads the symbol from a database.

The server 709 transmits a message back to the display device 701, with the message comprising the symbol which is associated with the identifier. This transmission is symbolically represented by means of an arrow with the reference numeral 711.

The symbol is, for example, the symbol 301 according to FIG. 3.

The display device 701 now displays the symbol 301 in response to reception of the message transmitted by the server 709 and comprising the symbol 301 in order to visually guide the person carrying the mobile terminal 703.

In addition to the symbol 301, the message of the server 709 can also comprise one or more item(s) of travel information for the person on the display device 701, wherein according to this embodiment the display device 701 visually also displays the one or more item(s) of travel information in addition to the symbol 301.

The display device 701 is arranged, for example, within a railway station. When the person with the terminal 703, which is, for example, a mobile telephone, comes within BLE range of the display device 701, the BLE signals are transmitted and received as described above. The position of the mobile terminal 703 and thereby the position of the person who is carrying the mobile terminal device 703 are therefore known: the person must be located within the BLE range of the display device 701.

FIG. 8 shows a display device 801 and a further mobile terminal 803.

The display device 801 emits a BLE signal, with this BLE signal comprising a display device identifier of the display device 801. The display device identifier indicates or identifies the display device 801.

An identifier within the meaning of the description comprises, for example, the following information: UUID, major, minor, region.

A display device identifier within the meaning of the description comprises, for example, the following information: major, minor, region.

The emission of the BLE signal is indicated symbolically by an arrow with the reference numeral 805.

The mobile terminal 803 receives the BLE signal and transmits a message to the server 709, this message comprising the display device identifier. Said transmission is carried out via a communication network, with said transmission being symbolically identified by an arrow with the reference symbol 807.

The message that the mobile terminal 803, which is a mobile telephone for example, transmits to the server 709 also comprises an identifier of the mobile terminal 803.

The server 709 receives this message from the mobile terminal 803 and ascertains the associated symbol based on the identifier of the mobile terminal 803.

Further, the server 709 ascertains on the basis of the display device direction identifier to which display device it should transmit the associated symbol.

Accordingly, the server 709 then transmits the symbol, which in this case is the symbol 301 by way of example, to the display device 801. Said transmission is symbolically identified by an arrow with the reference symbol 811. In addition to the symbol 301, further travel information can also be transmitted, for example, which can then, for example, likewise be displayed by the display device 801.

The display device 801 is arranged, for example, within a railway station. When the person with the terminal device 803, which is, for example, a mobile telephone, comes within BLE range of the display device 801, the BLE signals are transmitted and received as described above. The position of the mobile terminal 803 and thereby the position of the person carrying the mobile terminal 803, are therefore known: the person must be located within the BLE range of the display device 801.

A course of a conducted or guided journey of a person carrying a mobile terminal can be made or carried out, for example, as follows:

The traveler defines, for example, a symbol representing them once, which symbol can be, for example, an icon with their initial letter, or a symbol characterizing a hobby of the person, or a personalized emoji. For example, the symbol can be selected from libraries of thousands of symbols and can be, for example, personalized. For example, the symbol can be generated based on one or more photo(s). For example, the symbol can be newly created from scratch.

The symbol is therefore the identification for the person for, by way of example, all of their journeys which are still to be carried out or, for example, only for certain journeys, for example only for the next journey, for example only for a single journey.

Due to the fact that the symbol, as a rule, is known only to the traveler themself (or, if they communicate to their friends, also the latter), it can usually be displayed without data protection problems on public display devices, which can be, for example, screens. Since a sufficient number of other people is nearly always in the vicinity, it is usually difficult to infer the “owner” of the symbol, in other words the traveler. If data protection concerns should exist, it can be provided, for example, that a different symbol is defined by the traveler, in other words the traveling person, for each journey.

The traveler plans, for example, their route, in other words their journey, for example on the mobile terminal, for example on the smartphone, and/or on the web using a route planner. At the end of planning, they indicate, for example, that they wish to be visually guided. In this respect, on the basis of the inventive concept, they will obtain visual support during their journey.

For visually guiding the person it is provided that their symbol is displayed on display devices, which are located along their route, in particular with an item of direction information, in particular with an indication of the platform to be used, when the person is located in the vicinity of the corresponding display device.

For example, it is provided that in a passenger transport vehicle, which can be, for example, an underground train, it is indicated by means of the symbol on a display device arranged inside the passenger transport vehicle that the person has to exit at the next stop.

It is therefore provided in particular that the traveler is registered, for example, with the server, which can also be referred to as a travel guidance service, and this transmits the identifier of their mobile terminal and their symbol and their planned route. The server correlates the identifier, the symbol and the route with one another, so that, on the basis of the identifier, the symbol which represents the person who is carrying the terminal and the corresponding route of this person can be advantageously efficiently ascertained.

This means that the server knows the destination position. For example, the server ascertains possible travel alternatives, and this can be relevant in particular in the event of delays.

The server monitors progress of the journey by ascertaining the position of the mobile terminal during the journey. The current position of the mobile terminal can be ascertained, for example, on the basis of a transmission and reception of corresponding radio signals, as described above and below. Since, as a rule, the radio signals only have a particular range, the mobile terminal must be located within a particular range of a particular display device.

The positions of the display devices are known.

The server knows in particular the neuralgic locations or points at which display devices are arranged. In this respect the server can break down the route into individual steps, in that it guides the traveler from display device to display device by means of the visual display of the symbol.

The display devices are, for example, funded by advertising, for example partially funded by advertising.

A display device within the meaning of the description is, for example, connected to the server via the Internet.

A display device within the meaning of the description is used, for example, with the mobile terminal belonging to the person. Communication is carried out in particular after a single activation without the person having to constantly manually initiate or confirm the communication.

A display device within the meaning of the description transmits or receives radio signals, for example BLE signals, which can comprise, for example, the following elements: major, minor, region, to or from the mobile terminal, and displays, for example, information which the display device receives from the server via the Internet.

On the software side it is provided, for example, that an operating system, for example Android or Linux, is executed on a display device within the meaning of the description.

On the software side it is provided, for example, that a program, for example an app, is executed on a display device within the meaning of the description.

The program, for example the app, controls the display device in such a way that the latter extracts the identifier of the mobile terminal from the received radio signal and displays the symbol and travel information corresponding to the person.

For example, the mobile terminal or the display device is configured as an iBeacon or as a BLE beacon.

In one embodiment the display device detects the BLE signal, then communicates with the server (transmits the identifier of the terminal to the server), receives from the latter the associated symbol and, for example, travel information still relevant to the person and displays it. The identity of the person is therefore not known.

In a further embodiment it is provided that the mobile terminal receives a BLE signal transmitted by the display device, with said BLE signal comprising the display device identifier (which can also be referred to as a beacon ID). This beacon ID is therefore associated with the display device. The display device can therefore be identified by way of this beacon ID.

The mobile terminal transmits this beacon ID and its identifier to the server. The server ascertains the associated display device on the basis of the beacon ID and ascertains the associated symbol on the basis of the identifier and transmits the symbol to the ascertained display device. In addition, the server transmits, for example, further relevant travel information to the display device, so that the display device can display the symbol and, for example, the travel information. In this case as well, the identity of the person is not known.

Since the symbol, the identifier and the route are correlated with one another, the server, when it receives the identifier, can ascertain the symbol and the route and ascertain travel information relevant to this route hereby.

The invention is therefore based, inter alia, on the idea of using symbols, for example icons, for personalization and easier recognition of the person, who is represented by the symbol, it being possible to maintain a private sphere of the person at the same time.

Furthermore, the invention is based in particular on the idea of integrating route or journey planning into a system for visually guiding a person, with the system comprising a processor, which is, for example, incorporated by the server, and one or more display device(s). These display devices display the travel information, for example, in addition to the symbol, in other words display this in place of sole depiction of this information on the mobile terminal.

The invention is further based, for example, on the idea that, for example, an app, in general a program, is executed in a display device in order to efficiently communicate with a mobile terminal or a plurality of mobile terminals and the server. As a result, time delays, which can occur when using methods which communicate with the server via a web browser, can be advantageously avoided.

FIG. 9 shows a further system 901 for visual guidance.

The system 901 comprises a server 903 having a processor (not shown). The server 903 has a route planning function 905 and a symbol assigning function 907.

The system 901 further comprises a plurality of display devices 909, with two display devices 909 being drawn by way of example here. The display devices 909 are each operated by means of a computer 911, which can be designed, for example, as an embedded computer (embedded PC). The embedded computer 911 is, for example, integrated in the display device 909.

A traveler 913 carries a mobile terminal 915. The traveler 913 plans, for example for their journey, a route using the route planning function 905 of the server 903. The server 903 therefore knows the route of the traveler 913.

The traveler 913 selects, for example, a symbol from a large number of symbols which is intended to identify them, with the large number of symbols being provided by the server 903. For example, the symbol is an emoji.

The mobile terminal 915 of the traveler 913 transmits its UUID to the server 903. The server 903 assigns the selected symbol and the UUID using the symbol assigning function 907 to the route. This means that the route, the UUID and the symbol are correlated with one another.

The implementation of the route planning, selection of the symbol and transmission of the UUID are symbolically represented by means of an arrow with the reference numeral 916.

Since the server 903 knows the route it can use the display devices 909, which are arranged along the route, for visually guiding the traveler 913. The positions of the display devices 909 are known to the server 903.

During their journey along the route the traveler 913 will come within radio range of one of the display devices 909. Their mobile terminal 915 transmits, for example during the journey, a BLE signal comprising the UUID. The display devices 909 receive the BLE signal, and this is symbolically represented by means of broken-line arrows with the reference symbol 917.

If the display device 909 receives the BLE signal comprising the UUID, the corresponding computer 911 of the display device 909 transmits a request to the server 903 that the server 903 should return the symbol associated with the received UUID. The server 903 receives this request and, on the basis of the correlation performed, can ascertain the symbol associated with the UUID and send it to the computer 911. The computer 911 thereupon operates the display device 909 in such a way that the latter displays the symbol of the traveler 913 in order to visually guide the traveler 913.

The traveler 913 does not necessarily have to look at their mobile terminal 915 during their journey therefore, but instead looks at the display devices 909, which are symbolically represented by means of an arrow with the reference numeral 919.

One of the display devices 909 is arranged, for example, within a passenger transport vehicle and displays the symbol immediately before the next station at which the traveler 913 has to exit in order to continue to travel along their route.

One of the display devices 909 is arranged, for example, within a railway station on a track platform, so that displaying of the symbol signals to the traveler 913 at which platform they have to board their train in order to continue to travel along their route.

One of the display devices 909 is arranged, for example, at an exit of a railway station which has a plurality of exits, so that displaying of the symbol signals to the traveler 913 through which exit they should leave the railway station in order to continue to travel along their route.

The inventive concept is therefore based on the use of a plurality of spatially distributed display devices which visually guide the traveler, in other words the person, in a similar manner to beacons, along their route. In this case, the display devices display the symbol as a beacon in a similar manner to light beacons, on the basis of which the traveler can orientate themself.

The inventive concept can be divided, for example, into three parts 921, 923 and 925.

Part 921 designates the digital world and comprises the server 903 which, for example, can be arranged in a data center.

Part 923 designates the real world (in the “field”) and comprises the permanently installed display devices 909 with their computers 911

Part 925 designates the real world (in the “field”) and comprises the mobile identifier means, for example the mobile terminal 915. Mobile in that the traveler 913 with their identifier means, in this case by way of example the terminal 915, moves, in other words is mobile.

Although the invention has been illustrated and described in detail by the preferred exemplary embodiments, it is not restricted by the disclosed examples and a person skilled in the art can derive other variations herefrom without departing from the scope of the invention.

1-10. (canceled)

11. A method for visually guiding a person who is carrying an identifier means having an identifier and who is traveling along a route from a starting position to a destination position, wherein the route of the person traveling being planned using a route planning function provided by a server having a processor, so that the server knows the route, the method comprises the following steps of:
correlating the identifier, a symbol representing the person and the route with one another by the processor;
ascertaining a current position of the identifier means using the identifier by means of the processor while the person is traveling along the route; and
displaying the symbol on a basis of an ascertained position and of the route by means of at least one display device, the display device being different from the identifier means, and disposed along the route in order to visually guide the person along the route from the starting position to the destination position.

12. The method according to claim 11, wherein:
the at least one display device, in response to reception of a radio signal, emitted by the identifier means and containing the identifier, transmits a message containing the identifier about reception of the radio signal emitted by the identifier means to the server via a communication network; and
the server, in response to reception of the message transmitted by the at least one display device, transmits the symbol corresponding to the identifier to the at least one display device via the communication network.

13. The method according to claim 11, wherein:
the identifier means is a mobile terminal;
the at least one display device emits a radio signal containing a display device identifier; and
the server, in response to reception of a message transmitted by the mobile terminal via a communication network and containing the display device identifier and the identifier, transmits the symbol corresponding to the identifier via the communication network to the display device corresponding to the display device identifier.

14. The method according to claim 11, wherein:
the at least one display device is disposed within a passenger transport vehicle stopping at a plurality of stations; and
the one display device displays the symbol immediately before a next station at which the person has to exit during a course of a journey.

15. The method according to claim 11, wherein the at least one display device is disposed at a stop, for example on a track platform or on a bus platform, at which the person must board a passenger transport vehicle during a course of a journey.

16. The method according to claim 11, wherein prior to correlating, the person is provided with a plurality of symbols from which the person can select the symbol to be correlated so that the symbol selected by the person is used as the symbol to be correlated.

17. The method according to claim 11, wherein in addition to the symbol, displaying travel information based on the route for the person by means of the at least one display device.

18. The method according to claim 11, which further comprises selecting the at least one display device from the group consisting of a screen, a video projector, and a laser projector.

19. A system for visually guiding a person who is carrying an identifier means containing an identifier and who is traveling along a route from a starting position to a destination position, the system comprising:
a server providing a route planning function, so that the route of the person traveling has been planned using the route planning function, so that the server knows the route, the server having a processor for:
correlating the identifier, a symbol of the person representing the person and the route with one another; and
ascertaining a current position of the identifier means using the identifier while the person travels along the route; and
at least one display device different from said identifier means and disposed along the route for displaying the symbol depending on an ascertained position in order to visually guide the person along the route from the starting position to the destination position.

20. A non-transitory computer readable medium containing computer-executable instructions for carrying out a method according to claim 11, when the computer executable instructions are executed on a computer.
